(19) United States
(12) Patent Application Publication
(10) Pub. No.: US 2004/0266461 A1
(43) Pub. Date: Dec. 30, 2004

(54) Method and system for transmitting data

(76) Inventors: Mark Beckmann, Braunscweig (DE); Michael Eckert, Braunscweig (DE); Martin Hans, Hildesheim (DE); Andreas Otte, Celle (DE)

Correspondence Address: BELL, BOYD & LLOYD, LLC, P. O. BOX 1135, CHICAGO, IL, 60690-1135, US

(21) Appl. No.: 10/495,904

(22) PCT Filed: May 2, 2003
(86) PCT No.: PCT/DE03/01408

(30) Foreign Application Priority Data
May 24, 2002 (DE) 10223204.0

(51) Int. Cl. H04Q 7/20

(52) U.S. Cl. 455/466; 455/422.1

(57) ABSTRACT

The present invention relates to a transmission method in a mobile radio system, particularly a UMTS, including the following steps: parameters for receiving a multiply used channel are transmitted from a base station to a mobile station; the parameters are evaluated in the mobile station; and the mobile station receives data that has been transmitted by the base station via the multiply used channel, the reception being made possible via the parameters which are known to all mobile stations supplied by the base station. Preferably, the parameters are transmitted into the service area of the mobile station.

### BACKGROUND OF THE INVENTION

The present invention relates to a method and system for transmitting data in a mobile radio system.

Methods or, as the case may be, systems of such type are employed in, inter alia, mobile radio systems of the third generation, such as UMTS (Universal Mobile Telecommunications System).

In the mobile radio system of the UMTS third generation, information is transmitted to a user by reserving a physical resource. A distinction is made in mobile radio between two transmission links when data, of whatever type, is transmitted. The transmission of data from the generally stationary base station (term used in the GSM Global System for Mobile Communications) or, as the case may be, “node B” (term used for a base station in UMTS) to the mobile terminals (in UMTS mobile stations) is generally referred to as transmission on what is termed the “downlink”. The transmission of data in the opposite direction from a terminal to the base station is referred to as transmission on what is termed the “uplink”. Two modes are provided in UMTS for transmission over the air interface: in the Frequency Division Duplex (FDD) mode, transmission on the uplink and downlink takes place using different frequencies; in the Time Division Duplex (TDD) mode only one carrier frequency is employed. Uplink and downlink are separated through the assignment of timeslots. The users are separated in both modes through the application of orthogonal codes, what are termed channelization codes, onto the information data. This multiple access system is known as the CDMA (Code Division Multiple Access) system. According to technical specification TS 25. 211 V3. 7. 0: “Physical Channels and Mapping of Transport Channels onto Physical Channels” of the 3rd Generation Partnership Project (3GGP), which describes the UMTS-FDD mode, a physical channel, which is to say a radio channel, is defined on the downlink by a carrier frequency, a scrambling code, a channelization code, and a start and stop times. For transmission on the uplink, each mobile radio station has its own scrambling code. The purpose of scrambling codes is to enable the different mobile radio stations to be separated.

There are two types of radio channels in UMTS for transmitting information: dedicated channels and common channels. In the case of dedicated channels, a physical resource is reserved only for transmitting information for a specific user device, termed “user equipment” (UE) in UMTS. In the case of common channels it is possible to transmit information intended for all users or for one specific user only. The latter instance requires co-transmission on the common channel of an indication of the user for whom the information is intended.

FIG. 1 shows the known architecture of the UTRAN (Universal Terrestrial Radio Access Network) UMTS network having a Core Network (CN), a Radio Network Controller (RNC), node B1 and node B2 base stations, and a mobile station UE. An “s” suffixed to a defined unit stands below for plural units.

FIG. 2 shows a UMTS protocol architecture. The layers 2 and 3 shown therein are contained both once in the UE and once in the RNC. The letter “L” followed by a number corresponds to a layer; L2, for example, is layer 2. “c”, furthermore, stands for control. The protocol layers shown in FIG. 2 are

the Radio Resource Control (RRC) layer, which is to say lower layer 3, which is described in technical specification TS 25. 331 “Radio Resource Control” of the 3rd Generation Partnership Project (3 GPP), March 2001;

the Packet Data Convergence Protocol (PDCP) layer, which is to say upper layer 2, which is described in technical specification TS 25. 321 “Packet Data Convergence Protocol” of the 3rd Generation Partnership Project (3GPP), March 2001;

the Broadcast/Multicast Control (BMC) layer, which is to say upper layer 2, which is described in technical specification TS 25. 324 “Broadcast/Multicast Control” of the 3rd Generation Partnership Project (3GPP), March 2001;

the Radio Link Control (RLC) layer, which is to say middle layer 2, which is described in technical specification TS 25. 322 “Radio Link Control” of the 3rd Generation Partnership Project (3GPP), March 2001;

the Medium Access Control (MAC) layer, which is to say lower layer 2, which is described in technical specification TS 25. 321 “Medium Access Control” of the 3rd Generation Partnership Project (3GPP), March 2001; and

the Physical Layer PHY, which is to say layer 1, which is described in technical specification TS 25. 302 “Services Provided by Physical Layer” of the 3rd Generation Partnership Project (3GPP), March 2001.

A protocol in the transmitter (RNC or UE) generally exchanges protocol data units (PDU) with the equal protocol in the receiver (UE or RNC), employing the services of the protocol layer beneath it for transporting the PDUs. For this, each protocol layer offers its services to the layer above it at what are termed service access points which, in order to make the protocol architecture easier to understand, are provided with customary and unique names. As can be seen in FIG. 2, the service access points above the PDCP, BMC, and RLC protocols are referred to as radio bearers (RB), the service access points between the RRC and RLC protocols are referred to as signaling radio bearers (SRB), the service access points between the RLC and MAC protocols are referred to as logical channels (LogCH), and the service access points between the MAC protocol, which is the lowest protocol in layer 2, and the physical layer (layer 1) are referred to as transport channels (TrCH). The channels actually used for transmitting the data over the air interface are referred to as physical channels (PhyCH). In UMTS, all the physical channels of a transmission link are generally transmitted simultaneously over a common frequency band. To enable the individual physical channels, which are mutually superimposed during transmission over the air interface, to be mutually separated again in the receiver, UMTS employs the Code Division Multiple Access system CDMA in which the data being transmitted is modulated via what are termed spreading codes. A parameter by which, inter alia, a physical channel is described is therefore, the spreading code via which its data is spread or, as the case may be, modulated. Said parameter is present independently of the two FDD and TDD duplex modes specified in UMTS. The duplex mode describes how the two transmission links, downlink (DL, RNC->UE) and uplink (UL, UE->RNC) in a mobile radio connection are mutually separated. DL and UL are typically transmitted simultaneously on different frequency bands in the FDD mode, whereas in the TDD mode, although employing the same frequency band, DL and UL are transmitted at different times.

The further elucidations and explanations given below only apply to the UMTS-FDD mode. The tasks or, as the case may be, functions of the RRC protocol, MAC protocol, and physical layer necessary for understanding the present invention are explained below.

The RRC protocol is explained below. The RRC protocol is responsible for setting up, clearing down, and reconfiguring PhyCHs, TrCHs, LogCHs, and RBs, and for negotiating all the parameters of the layer 2 protocols and of the physical layer. Such protocol is present in both the UE and the RNC and uses the transmission services made available by the RLC protocol, which is to say the SRBs, for sending RRC configuration messages. When configuration messages are exchanged there is generally a configuring unit and a configured unit with, in UMTS, the RRC protocol of the RNC being, as a basic rule, the configuring unit and the RRC protocol of the UE being the configured unit. The configured unit (UE) is able to acknowledge receipt of a configuration message from the configuring unit (RNC) by sending a confirmation of receipt. The RRC protocols thus negotiate the configuration parameters which are required for setting up a connection and via which each individual RRC protocol in turn configures the protocols beneath it of layer 2 and configures layer 1. The configuration messages sent by the RRC protocol of the RNC generally can be divided into two types. On the one hand there are configuration parameters which are the same in terms of value and meaning for several UEs, and on the other hand there are configuration parameters which are only valid for a single UE. The RRC protocol of the RNC therefore sends configuration parameters which have equal validity for several UEs on logical channels which can be received by several UEs jointly, what are termed “common LogCHs”, and configuration parameters which are only valid for one UE on LogCHs which can only be received by one specific UE, what are termed “dedicated LogCHs”. For example, generally valid configuration parameters are sent over a broadcast control channel (BCCH) and UE-specific configuration parameters are sent over a dedicated control channel (DCCH).

The MAC protocol is explained below. The function of the MAC protocol in the transmitter is to map the data being applied to a LogCH above the MAC protocol onto the transport channels of the physical layer, or, as the case may be, to distribute data received on transport channels in the receiver among logical channels. For this, each transport channel is preconfigured with a set of fixed parameters for transmitting the data. The MAC protocol is able to choose from a further set of variable parameters the ones which are in each case most favorable for the current transmission and so dynamically influence the data transmission. A valid setting of all parameters for a transport channel is referred to here by the term transport format (TF). The totality of all possible settings for a transport channel is referred to by the term transport format set (TFS). The individual TFs in a TFS are identified by an indicator. Such indicator is referred to by the term transport format indicator (TFI). Only the variable (dynamic) parameters of the TF vary within a TFS. Only one transport format is set at a particular time for each transport channel. The totality of transport formats set at a particular time for all transport channels present is referred to by the term transport format combination (TFC). The transport formats valid for each transport channel together produce a great multiplicity of possible combinations for all transport channels, and each of these combinations could theoretically produce a TFC. There are, however, practical limitations on the number of combinations of transport formats actually allowed simultaneously. The totality of all allowed TFCs is referred to by the term transport format combination set (TFCS). The individual TFCs in a TFCS are also identified by an indicator, referred to by the term transport format combination indicator (TFCI).

As described above, a TF consists of static parameters which cannot be influenced by the MAC protocol but which are only negotiated by the RRC protocol, and of dynamic parameters of which a set of different settings is negotiated by the RRC protocol and which can be influenced by the MAC protocol. The static parameters include:

the length of the transmission time interval (TTI), which is to say the length of time for which the physical layer processes data on a coherent basis; this can be 10, 20, 40 or 80 milliseconds,

the coding scheme for error protection; and

the length of the redundancy information for error protection CRC (Cyclic Redundancy Check).

The dynamic parameters are:

RLC size: As the MAC protocol neither generates MAC-PDUs nor segments or joins up the RLC-PDUs received from the RLC or, a MAC-PDU continues corresponding to precisely one RLC-PDU for as long as the MAC protocol does not prefix the RLC-PDU with a control data header, termed a MAC header. If the MAC protocol prefixes the RLC-PDUs with a control data header, the MAC-PDU will exceed the RLC-PDUs in size by the length of the MAC header. So the size both of the RLC-PDU and of the MAC-PDU is set by this parameter. The data block, the MAC-PDU, transferred on the transport channel to the physical layer is also referred to by the term transport block.

Number of transport blocks:

This parameter determines the number of MAC-PDUs that are allowed to be transferred during a TTI to the physical layer for simultaneous processing and transfer over the air interface.

As can be seen, the parameters TTI, RLC size, and number of transport blocks indicate the transport channel's momentary data rate, which can be set dynamically by the MAC protocol by way of selecting the various transport formats, which is to say by varying the TTI, RLC size, and number of transport blocks.

Over and above dynamically selecting a TFC for each transmission time interval (TTI) the tasks of the MAC protocol include, as already mentioned at the start, distributing data arriving on the various RBs among the transport channels, taking into consideration the quality of service (QoS) set for the RB. An RB's QoS describes the transmission quality to be ensured for the duration of the mobile radio connection by the protocols of layer 2 and of the physical layer. The QoS is here characterized by, for example, a specific guaranteed data rate and/or maximum transmission delay. When RBs are being set up and reconfigured, the RRC protocol negotiates, for example, which logical channels are to be mapped onto which transport channels, with the possibility of assigning each transport channel several logical channels.

FIG. 3 shows the architecture of the MAC protocol in the RNC reduced to the UMTS-FDD mode, with there being a separate dedicated MAC-d (MAC-dedicated) MAC unit for each UE provisioned by an RNC. Abbreviations already described have the same meaning in FIG. 3. Sent via the MAC-d unit on the DL and received on the UL is exclusively UE-specific useful and control data which reaches the MAC-d unit via the relevant logical channels, the dedicated traffic channel (DCCH), and the dedicated control channel (DTCH). There is at least one separate transport channel, what is termed a dedicated transport channel (DCH), for each transmission link. A DCH of this type is mapped by the physical layer onto one or more dedicated physical channels (DPCH) and transmitted over the air interface. By contrast, useful and control data which is not UE specific is generally transmitted over the MAC-control/shared (MAC-c/sh) unit shown in FIG. 3. Said data reaches the MAC-c/sh unit via the logical channels common traffic channel (CTCH) and common control channel (CCCH). The CTCH only exists on the DL and is transmitted via the FACH (Forward Access Channel) transport channel to the physical layer. The CCCH, by contrast, exists on both the DL and the UL and so is carried on the DL by the FACH and on the UL by a random access channel (RACH). Via the MAC-c/sh unit it is also possible to transport system information which is the same for all UEs. The system information reaches the MAC-c/sh unit via the logical BCCH (Broadcast Control Channel) channel. The BCCH is a radio control channel existing only on the DL and generally can be mapped onto two different transport channels. The BCCH also can, on the one hand, be carried by the FACH. On the other hands it can be mapped onto the transport channel BCH (Broadcast Channel) by a further MAC unit which is not shown in FIG. 3 and which is referred to by the term MAC-b (MAC-broadcast) MAC transmission unit.

The MAC-c/sh unit is also able to send or, as the case may be, receive UE-specific useful and control data. This is the case, on the one hand, when a UE has not, at the current time, set up a dedicated transport channel DCH but nonetheless wishes to receive or send small amounts of UE-specific data. From the RNC's viewpoint, in a case such as this the data is routed on the DL from the MAC-d unit to the MAC-c/sh unit, whereupon such unit transfers the data via the FACH to the physical layer. In a case such as this the data is received on the UL on the RACH, to then be forwarded from the MAC-c/sh to the MAC-d.

On the other hand a UE can have set up a DCH, but its capacity is meanwhile too small to transmit a certain volume of data in a specific transmission time interval. This can be the situation in the case, for example, of a data stream which over its temporal course has what are termed peaks in the volume of data and which is generally referred to by the term bursty data stream (BDS). Additional capacities therefore are made available to the UE for the relevant period of time to enable it to receive the required volume of data in a specific transmission time interval. The additional capacities exist in what is termed a shared channel for a transmission on the downlink—DSCH (Downlink Shared Channel). This is a transport channel which only exists on the DL and which is shared by several UEs for receiving dedicated data over such channel. At any particular instant and for a specific period of time the DSCH is only assigned to a maximum of one UE. At another instant it is, however, readily possible for the same DSCH resources to be assigned to another UE. The DSCH is here mapped by the physical layer onto one or more physical shared channels for a transmission on the downlink PDSCH (Physical Downlink Shared Channel) which, inter alia, are again characterized by specific spreading codes.

The function of the MAC protocol can be summarized as follows: The sending MAC protocol selects a transport format for each TTI and each TrCH (which is to say one TFC overall) and determines from which LogCHs data is transmitted in the TTI under consideration. The MAC protocol then notifies the relevant RLC units of the RLC-PDU size belonging to the respective TF and number of expected RLC-PDUs. The RLC protocols then transfers the relevant number of RLC-PDUs on the relevant logical channel to the MAC protocol. Such protocol adds, where applicable, a MAC header field to the data and transfers all the MAC-PDUs for a transport channel simultaneously to the physical layer. When this is done, the MAC protocol of the physical layer additionally transfers each transport channel's TFI which is current for the TTI.

The physical layer is described as follows: The function of the physical layer is to send the data received via the transport channels from the MAC protocol over the air interface within the relevant TTIs of the transport channels. For this, with the aid of the individual TrCHs' TFIs transferred by the MAC protocol, the physical layer determines, inter alia, the length of the redundancy information for error protection (CRC), the channel coding system, the code rate, and the duration of the TTI in which the data of a TrCH is to be transported over the air interface. The physical layer uses this information to calculate the CRC sum for each transport block of a TrCH which is to be transmitted in the relevant TTI and appends such sum to the data. All the transport blocks of a TTI of a TrCH are then jointly channel-coded to protect them from transmission errors which can be caused by the transmission channel. When all the data of a transport channel has been prepared via further measures, described in more detail in technical specification TS 25. 212 “Multiplexing and channel coding (FDD)” of the 3rd Generation Partnership Project (3GPP), March 2001, for transmission over the air interface, the data of all transport channels is multiplexed onto an internal channel in the physical layer. Such channel is referred to by the term coded composite transport channel (CCTrCH). When this is done, generally all dedicated transport channels (DCHs) of a UE are mapped onto a CCTrCH and all DSCHs of a UE are mapped onto a further, separate CCTrCH. The data being sent is in turn mapped from a CCTrCH onto the relevant physical channels which are responsible for transmitting the data over the air interface. When this is done, the data of the CCTrCH carrying the dedicated transport channels (DCHs) of a UE is mapped onto DPCHs and the data of the CCTrCH carrying the DSCHs of a UE is mapped onto PDSCHs. Such data is then modulated before being sent over the air interface and coded, which is to say spread, via the spreading code specific to the relevant DPCH or, as the case may be, PDSCH.

To enable the physical layer in the receiver to correctly decode the data received over the various DPCHs or, as the case may be, PDSCHs, which is to say rescind the measures (spreading, modulating, multiplexing, channel coding, etc.) performed for the purpose of adapting the data to the air interface, and to enable the MAC protocol in the UE to perform error-free demultiplexing of the data received over the transport channels onto the logical channels, from the TFIs of the transport channels the physical layer of the transmitter determines the TFC applicable to the current TTI and therefrom, in turn, the associated TFCI. A TFCI of this type is generally 10 bits long and is transmitted jointly with the data of the CCTrCH carrying the dedicated transport channels via a DPCH to the UE. The UE is thus able, via the received TFCI, to rescind the measures performed on the data on the transmitter side and so decode the data generally error-free.

The TFCI is here generally specific to each CCTrCH, which is to say that two different TFCIs have to be notified to a UE for which two CCTrCHs have been configured (one for DCHs and one for DSCHs). However, in order to save transmission capacities usually only a single 10-bit TFCI is sent to a UE.

As described above, a DSCH which is mapped from the physical layer in the transmitter onto a separate CCTrCH, and from there onto one or more PDSCHs, generally serves to clear down data peaks occurring in the case of, for example, what are termed bursty data streams (BDS). It is a characteristic of a BDS of this type that the data peaks generally occur irregularly and suddenly. The transmitter (RNC) therefore must be enabled to notify the UE quickly and in an uncomplicated manner of the additional capacities which are required for transmitting the data peaks and are present in the form of the PDSCHs. Explicit signaling of the additional resources is for that reason of no practical advantage as it would take too long. That is because it first would be necessary to send a configuration message from the RRC in the RNC to the RRC in the UE over the air interface in order to configure the physical layer and MAC protocol of the UE with the parameters contained in the message. The UE is therefore notified of the additional capacities implicitly by the RNC. The already mentioned 10-bit-long TFCI is used for this.

During the configuration of an RB, whose data flow has the characteristics of a BDS, the configuring unit (RNC) is aware that additional capacities in the form of one or more PDSCHs are required from time to time on the DL in order to transmit a required amount of data to the UE in a specific period of time referred to as a frame. The consequence of this is that a DSCH is configured on the DL for the UE. As such, the UE is notified of the requisite parameters needed for receiving a DSCH. Such parameters include the TFS of the DSCH, the TFCS of the CCTrCH belonging to the DSCH, and the specific spreading codes of the PDSCHs onto which one or more DSCH are mapped. The RRC (re-)configuration message, which makes the previously described parameter known to a UE, can be present in various forms, for example as what is termed a radio bearer setup, as what is termed a radio bearer-reconfiguration, or as what is termed a transport channel-reconfiguration. The radio bearer setup message described in technical specification TS 25. 331 “Radio Resource Control” of the 3rd Generation Partnership Project (3GPP), March 2001, is shown schematically in FIG. 4. Such message can contain the information required for setting up several RBs and hence also the information for setting up several DSCHs. FIG. 4 and FIGS. 5 and 6 show at what location in the “RB SETUP” message the previously mentioned parameters are notified to a LE by what are termed information elements (IEs). Expressions already defined have the same meaning in this case, too. A suffixed “IE” signifies in the following that the abbreviations already explained are in each case an information element. MS signifies the type of message.

The TFS of each DSCH is explicitly signaled to a UE by the IE “TFS” (Transport Format Set). Such IE is generally contained once in the “RB SETUP” message for each transport channel which is to be set up, regardless of whether it is a DCH or DSCH. What is transferred to the UE with the “TFS” are the dynamic parameters (RLC size, number of transport blocks) for each TF in the TFS of the relevant transport channel and, once only, the semi-static parameters which are constant for the TFS. As can be seen in FIG. 4, the IE “TFS” is transmitted in the IE “Add/Reconf. DL TrCHinfo#1,2” (#22 in FIG. 4). Apart from the IE “TFS” (#23 in FIG. 4), this contains another important parameter referred to by the term “DCH quality objective”. With the aid of this parameter the UE establishes the reference value of the signal-to-interference ratio (SIR) for the DPCHs or, as the case may be, PDSCHs required for a transport channel. If such value is undershot or exceeded on, for example, the DL, the UE will signal to the transmitter that it should increase or reduce the transmit power in the next frame. The “DCH quality objective” parameter is therefore required for controlling the power of the PDSCHs belonging to the DSCHs.

The UE receives the TFCS of the CCTrCH onto which one or more DSCHs are mapped from the physical layer in the transmitter, in order then to be distributed among the various PDSCHs, via the IE “TFCS” (Transport Format Combination Set) contained in the IE “DL transport channel information common for all transport channels” (DLTrCHIcfaTrCH).

As can be seen in FIG. 5, in the IE “TFCS” a UE is first given information about the configuration of the previously mentioned TFCI sent onto a DPCH to the UE during transmission into each frame together with the data. If, for instance, none of the RBs to be set up for a UE requires a DSCH, the TFCI will be configured by the IE “TFCS” as “normal”, which is to say that all 10 bits of the TFCI describe for each frame exclusively the TFC of the CCTrCH carrying the dedicated channels (DCHs) of a UE. If, on the other hand, only one of the RBs to be set up for a LE requires a DSCH, then what is termed a split will be configured for the TFCI, which is to say that the TFCI in this case consists of two fields. The terms TFCI field 1 and TFCI field 2 are employed in this connection. The length of the second field is explicitly notified in the IE (length of the TFCI(field2)) and the length of the first field is indicated by this implicitly. While data is being transmitted, TFCI field 1 contains the TFCI of the CCTrCH carrying the dedicated transport channels of the UE, and TFCI field 2 contains the TFCI of the CCTrCH onto which the DSCHs of a LE are mapped. The actual TFCSs of the relevant CCTrCHs are made known to the UE by the IEs “TFCI field 1 info” and “TFCI field 2 info”. The IE “TFCS explicit configuration”, which assigns a TFC of the TFCS to each value of TFCI field 2, is in turn contained, inter alia, in the IE “TFCI field 2 info”. A UE is thus informed in this way of the TFCS of the CCTrCH carrying the DSCHs of the relevant UE (#24 in FIG. 5). The UE is therefore signaled, via the receipt of the bit a total of 10 bits in length, when the physical layer of the UE has to receive one or more PDSCHs in order to obtain additional data on one or more DSCHs via such PDSCHs. Such signaling generally takes place one frame in advance, which is to say one frame ahead of the relevant frame in which the UE is to receive additional data on one or more DSCHs. If the value of a received TFCI field 2 corresponds to a TFC indicating to the UE that the MAC protocol in the transmitter (RNC) is not mapping any data onto the DSCHs configured for the UE in the next frame, the UE will know that it has no data to receive on a PDSCH in the next frame. If, conversely, the value of TFCI field 2 signals to a UE that the MAC protocol in the transmitter (RNC) is mapping data onto one of the DSCHs configured for the UE in the next frame, the UE will know that it has additional data to receive on one or more PDSCHs in the next frame. So that the UE knows on which and on how many PDSCHs it is to receive additional data, associated with the value of TFCI field 2 is not only is the current TFC of the relevant CCTrCH, but also information about the spreading codes of the PDSCHs on which the additional data is being sent from the transmitter to the UE. That is to say that, associated with each value of TFCI field 2 are, apart from a TFC for the relevant CCTrCH, the corresponding spreading codes of the PDSCHs transmitting the data of one or more DSCHs. The assignment of the spreading codes of the required PDSCHs to the values of TFCI field 2 likewise is made known to the UE via the “RB SETUP” message. Contained in such message among the “PhycHs” are the IEs notifying a UE of the parameters required for receiving the physical resources. The parameters required for receiving one or, as the case may be, several PDSCHs are signaled to a UE via, for example, the IE “PDSCH DL information,” which in turn contains, inter alia, the IE “PDSCH code mapping” (#25 in FIG. 6). The assignment of one or more spreading codes (corresponding to one or more PDSCHs) to the values of TFCI field 2 is contained in the last cited IE.

If a UE is configured in the above described manner, it will be able to determine for each frame whether in the following frame it has been assigned additional resources by the transmitting unit (RNC) in the form of PDSCHs, how many additional resources it has been given, and via which spreading codes the relevant resources (PDSCHs) have been coded. It is emphasized here that both the “RADIO BEARER SETUP” configuration message described here and the “RADIO BEARER RECONFIGURATION” and “TRANSPORT CHANNEL RECONFIGURATION” configuration messages are generally transmitted over a dedicated logical control channel (DCCH) from the RRC in the RNC to the RRC in the UE. The settings performed via the configuration messages for receiving DSCHs and the associated PDSCHs are hence only known to the relevant UE. This is of practical advantage because the resource of a DSCH can only be assigned or, as the case may be, allocated to a single UE at a particular time. It is, however, conceivable in different applications for the intention to be for data sent on one or more DSCHs to be received by several UEs simultaneously. An obvious prerequisite for this is for the configuration of the DSCHs to be the same for all UEs. According to the prior art, this requires transmitting a separate configuration message over a DCCH from the RRC in the RNC to the RRC in the UE to each UE which is to receive the data on the relevant DSCHs. However, this unnecessarily reduces the available transmission capacities of the air interface. The PDSCH is a pure data channel, which is to say that no signaling data whatever is sent over it from the transmitter (physical layer in the node B) to the UE. The PDSCH consequently can only exist in the UMTS-FDD mode in conjunction with a DPCH on the DL and in conjunction with a DPCH on the UL. This is not only because a UE is notified via a DPCH of the TFCI of the CCTrCH carrying the DSCHs of the UE; it is also because all power controlling of the PDSCHs configured for a LE is carried out via the DPCHs. For power controlling, in the case of transmission on the DL-TPC (Transmit Power Control) downlink the transmitter (node B) sends bits in the transmit power control channel together with the TFCI bits over the DPCH to the UE. Such TPC bits signal to the UE whether it is to increase or reduce the transmit power on the UL. On the DPCH of the UL the UE accordingly sends TPC bits signaling to the node B that it has to increase or reduce the transmit power on the DL. Depending on the TPC bits, the node B increases or, as the case may be, reduces the transmit power of the DPCHs and of the PDSCHs. A known PDSCH thus cannot exist without DPCHs.

An object of the present invention is, therefore, to provide a method and a system for transmitting data in a mobile radio system whereby the required signaling effort over the air interface is kept low.

### SUMMARY OF THE INVENTION

Accordingly, a method is provided for transmitting data in a mobile radio system, in particular UMTS, which includes the following procedural steps:

transmitting parameters for receiving a multiply used channel from a base station to a mobile station;

evaluating the parameters in the mobile station; and

the receiving by the mobile station of data which has been transmitted by the base station via the multiply used channel, reception being made possible by the parameters.

The parameters are known to all mobile stations supplied by the base station. The multiply used channel is preferably a shared channel for transmission on the downlink DSCH. The parameters are evaluated in the, at least one, mobile station, whereupon data is received from the mobile station via the multiply used channel. Reception of this type is made possible by the parameters. The parameters are preferably transmitted into the service area of the mobile station by radio. With this, what is termed, “broadcast” transmission, the parameters are consequently made known to all use-making mobile stations in the service area of the base station.

The multiply used channel is preferably a channel used principally for transmitting data peaks. Data the transmission of which could not be guaranteed in the case of transmission over normally existing transmission paths is consequently transmitted over it.

In an embodiment of the present invention, the parameters are transmitted at a level of transmit power which will ensure that they can be received throughout the service area of the base station.

In a further embodiment of the present invention, the data is received simultaneously by a multiplicity of mobile stations. This will ensure that the data can also be received over the multiply used channel by the multiplicity of mobile stations.

In a further embodiment of the present invention, the data is data which is sent to a group of mobile stations simultaneously. This relates to the multicast groups or, as the case may be, multicast data.

The object set out at the beginning is also achieved via a system for transmitting data into a mobile radio system, in particular UMTS. The system for transmitting data into a mobile radio system, in particular UMTS, has parts for sending parameters for the reception of a multiply used channel from a base station to a mobile station, parts for evaluating the parameters in the mobile station, and parts for the reception of data sent from the base station by the mobile station over the multiply used channel, with reception being made possible by the parameters. The parameters are made known to all the mobile stations supplied by the base station.

The present invention furthermore relates to a mobile station for use in association with a method according to the present invention and/or in a system according to the present invention. The present invention further relates to a base station for use in association with a method according to the present invention and/or in a system according to the present invention.

In the present invention, the parameters required for receiving DSCHs (or, as the case may be, PDSCHs) are made known in order to allow several mobile radio terminals to receive data on the DSCHs (or, as the case may be, PDSCHs) simultaneously and, at the same time, minimize the required signaling effort over the air interface.

An advantage of the present invention is that the parameters required for receiving DSCHs (or, as the case may be, PDSCHs) will not have to be notified to each UE individually over a DCCH if DSCHs (or, as the case may be, PDSCHs) are to be received simultaneously by several mobile radio terminals. The signaling effort over the air interface is thereby effectively reduced, which is equivalent to saving on transmission capacities. The saved transmission capacities can be used for transmitting useful data. This has the positive effect of increasing the mobile radio system's useful data rate and reducing the system's signaling rate.

A further advantage of the present invention is that, as a result of being made known generally, the relevant parameters already will be known in a mobile radio terminal even if the reception of data simultaneously with other mobile radio terminals on one or more DSCHs (or, as the case may be, PDSCHs) has not yet been provided for the relevant mobile radio terminal. If the relevant mobile radio terminal is to receive data on one or more DSCHs (or, as the case may be, PDSCHs) simultaneously with other mobile radio terminals, the parameters required for receiving the data can be established immediately. The time required to configure a mobile radio terminal for receiving data on the DSCHs (or, as the case may be, PDSCHs) is, thus, generally far less than in the case of the known solutions where a configuration message first has to be sent to the mobile radio terminal.

Additional features and advantages of the present invention are described in, and will be apparent from, the following Detailed Description of the Invention and the Figures.

### BRIEF DESCRIPTION OF THE FIGURES

FIG. 1 is a schematic of a UMTS network.

FIG. 2 is a schematic of the protocol architecture of the UMTS layers 2 and 3.

FIG. 3 is a schematic of a reduced MAC architecture.

FIG. 4 is a schematic of a radio bearer setup message.

FIG. 5 shows an item of DL transport channel information common to all transport channels.

FIG. 6 is a schematic of physical channel information elements.

FIG. 7 shows a type 6 system information block.

FIG. 8 shows an exemplary embodiment of a type 6 system information block.

FIG. 9 shows an exemplary embodiment of a type 6 system information block.

### DETAILED DESCRIPTION OF THE INVENTION

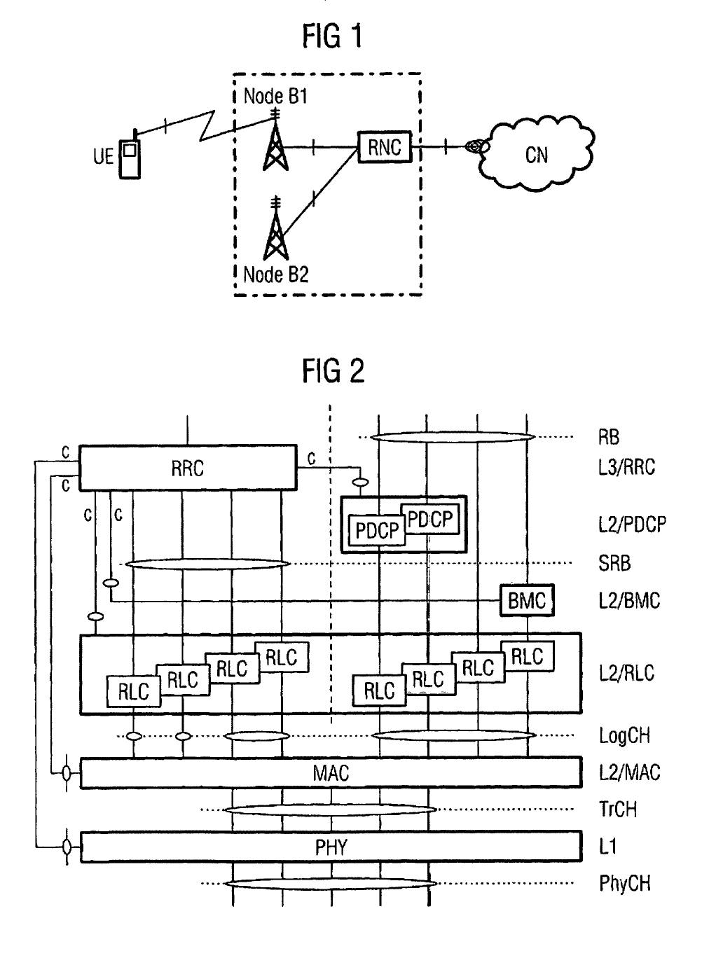

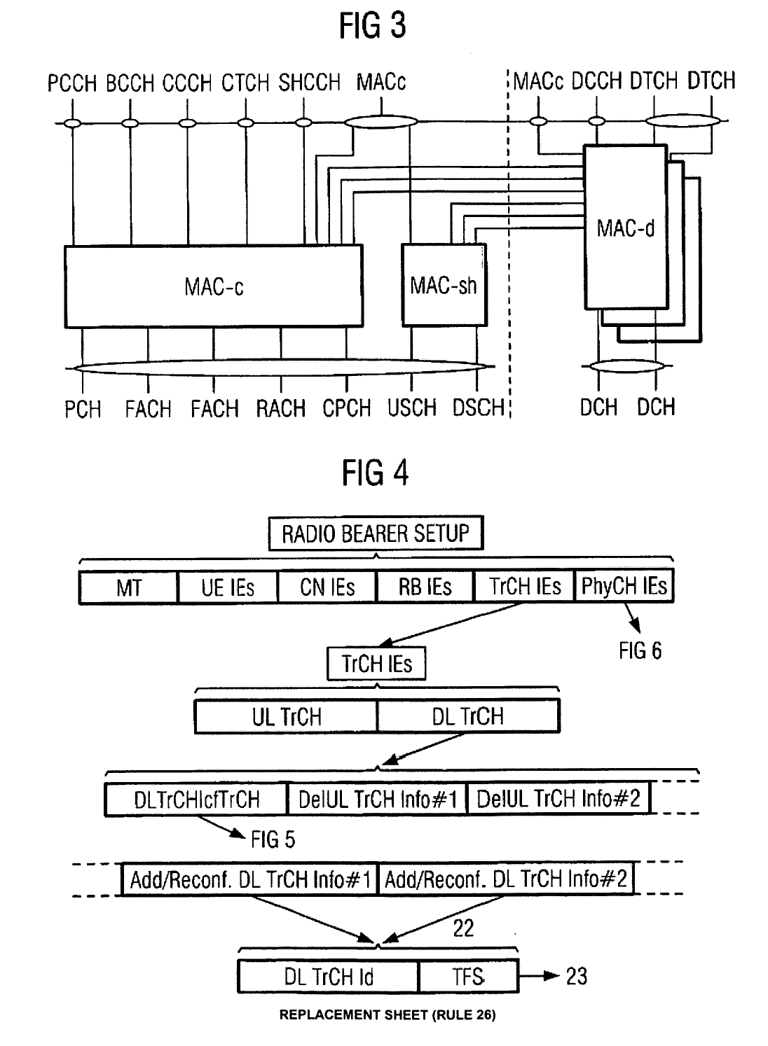

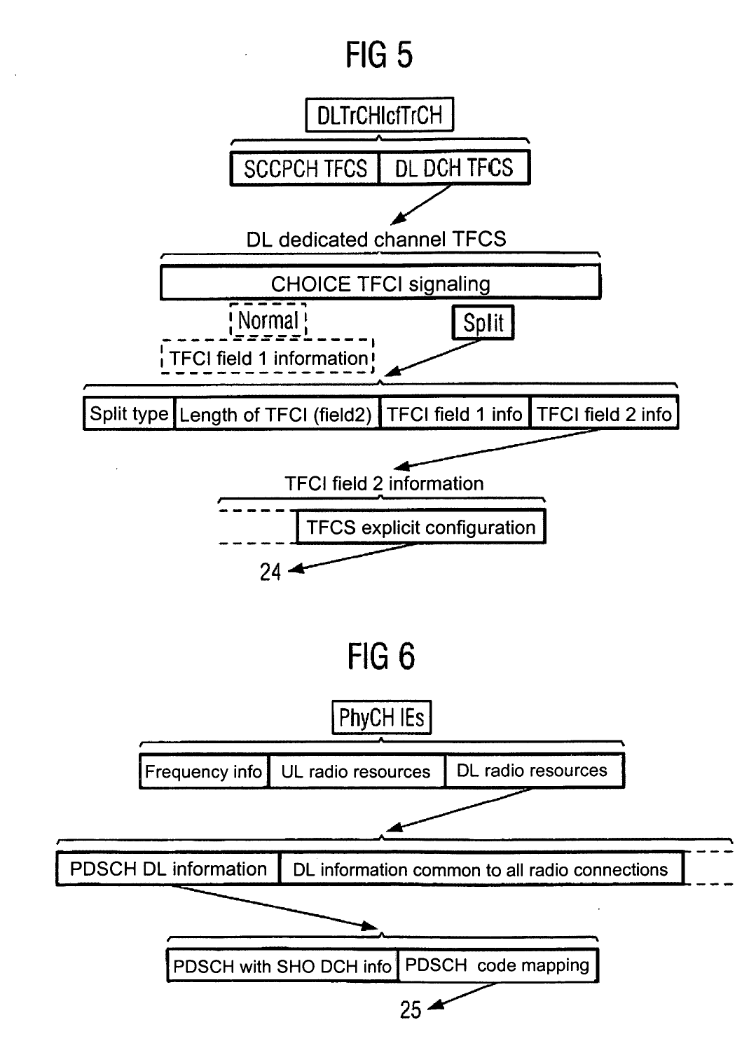

FIGS. 1 to 6 have already been described in the preceding, in the introduction of the description, whereby reference will be made to such description.

The exemplary embodiment below is based on a multicast service in a UMTS mobile radio system. Such multicast service entails sending data generally intended for a group of mobile radio users over a single common channel in order to save on transmission capacities of the air interface. The functions and tasks of a channel of this type can be assumed by, for example, the DSCH channel already described. A DSCH assuming the function of a channel of this type therefore will be referred to in the following by the term MC-DSCH “Multicast Downlink Shared Channel.” Such MC-DSCH is basically identical to a customary DSCH according to the prior art. A difference compared to the known DSCH is that the MC-DSCH is assigned not only to one mobile radio user or, as the case may be, UE at a particular time but also to several UEs simultaneously. The mobile radio users who receive an MC-DSCH simultaneously generally belong to the same multicast group (MC group). As such, a MC-DSCH is only allocated to one specific MC group at a particular time.

Proceeding from the fact that only one MC-DSCH is ever mapped to a relevant CCTrCH within a transmission frame, the parameters required for receiving the MC-DSCH are identical for all mobile radio users who are to receive the MC-DSCH at the same time. The parameters required by the relevant UEs of the mobile radio users for receiving the MC-DSCH and associated PDSCHs are the TFS of the MC-DSCH, the TFCS of the CCTrCH onto which the MC-DSCH is mapped, and the spreading codes of the PDSCHs on which the UEs are to receive the data of the MC-DSCH. If it is assumed that there is a separate CCTrCH for each MCDSCH, a TFC of the TFCS will always correspond to precisely one TF of the TFS of the MC-DSCH.

Power controlling of a MC-DSCH can be performed using two different methods: on the one hand, via the DPCHs of the users in an MC group and, on the other hand, via an additional physical channel designed specially for the multicast service. The two methods are distinguished in the following.

In the event that a mobile radio user wishes exclusively to receive one MC-DSCH and power controlling of the MCDSCH is performed via the TPC bits of the associated DPCHs, the DPCH on the DL will serve solely to transmit the shared 10-bit TFCI and the TPC bits. The reason for this is that the MAC protocol in the transmitter does not need to map any data onto a DCH. It is therefore of practical advantage to make a basic setting for the DCH mapped onto the DPCH generally known. The term basic setting here refers, for example, to a specific TF of the DCH, the TF signaling to the UE that it does not have to receive any useful data on the relevant DCH. It also is, however, possible for the entire TFS and an associated to be made generally known for the DCH.

In the event that power controlling of an MC-DSCH is to be ensured via an additional physical channel, a physical channel is described for the DL, the channel containing the TPC bits of all UEs belonging to an MC group and being referred to by the term multicast power channel (McPwCH). Each LE in the MC group is notified via such channel of whether or not in the next transmission frame it should increase the transmit power on the UL so that its TPC bits on the UL can continue being received error-free by the node B. An McPwCH of this type is, in turn, coded via a separate spreading code which is specific to the channel. A further parameter required for receiving an MC-DSCH and the associated PDSCHs is hence the spreading code via which the McPwCH is coded.

A feature of a variant of the McPwCH is that TPC bits are not exclusively sent over it. That is to say, a part of the McPwCH's overall capacity can be reserved for other control data or even for useful data. If one now considers the case of a UE's wishing exclusively to receive data of a multicast service and no data over dedicated channels (DCHs), then the UE of the mobile radio user requires the DPCH associated with the MC-DSCH solely, as described earlier, for transmitting the shared 10-bit TFCI. That being a waste of transmission capacities, it is of practical advantage for the TFCI of the CCTrCH onto which the MC-DSCH is mapped to be sent to the UE over the McPwCH. The TFCI will be transmitted within the McPwCH's transmission capacities reserved for other control data or for useful data. The UE of a mobile radio user wishing exclusively to receive one or more multicast services thus does not require a DCH associated with the MC-DSCH and hence does not require a DPCH, either. Since, however, a UE is notified while a DCH or, as the case may be, the associated DPCH is being set up of the reference value, mentioned in the prior art, for power controlling, in the exemplary embodiment described here the UE would not receive such value. Consequently, UE would not be able to perform proper power controlling. A further parameter, referred to by the term “MC-DSCH quality objective,” must be made known in order to ensure that a UE also will be able to perform proper power controlling in the event that a DCH or, as the case may be, DPCH is not associated with a MC-DSCH.

The above described parameters are now to be made generally known to the IEs of the mobile radio users via a system information block (SIB) instead of transmitting them to each UE via a separate message. An SIB of this type is generally sent from the RRC in the RNC via the logical channel BCCH to the MAC protocol. The MAC protocol thereupon maps the BCCH onto the transport channel BCH. The BCH is then transmitted from the physical layer in the transmitter (node B) at a power level which will ensure that the BCH can be received throughout the service area of the node B. The information on the BCH can be evaluated by any of the UEs located in the service area of the node B. The information sent via the BCH is thus generally made known. “Broadcasting” of system information is the term employed in this connection. The parameters required for receiving an MC-DSCH and the associated PDSCHs now can be notified to the UEs of the mobile radio users in an MC group by means of an SIB already specified in the UMTS, its then being necessary to modify said SIB accordingly, or can be made known to the UEs via a separate SIB to be introduced solely for the multicast service.

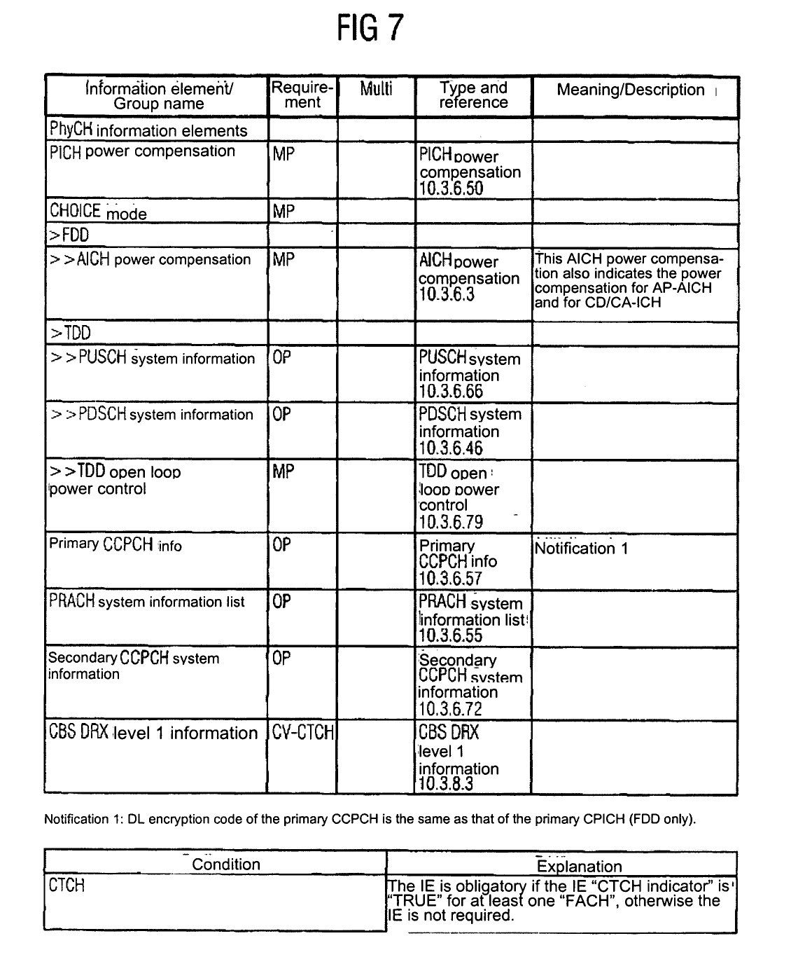

FIG. 7 shows in table form the type 6 system information block (SIB 6) according to the prior art. Such block is taken from the specification of the RRC protocol and is described in more detail in technical specification TS 25. 331 “Radio Resource Control” of the 3rd Generation Partnership Project (3GPP), March 2001. The various information elements of the SIB have been entered in rows in FIG. 7, and in the first column the name of the element and, where applicable, a hierarchical structuring of the element with the aid of the symbol “>”, in the second column an indication of whether the element has to be present (MP=“Mandatory Presence”, OP=“Optional”, CV X=“Conditional Value”, dependent, therefore, on X, with X being defined below), in the third column, where applicable, an indication of the multiple presence of the element, and further information in other columns. The effect of the “OP” indication is that the IE starts in a bit representation with information indicating whether further information of this element is present. As this information can be represented by, for example, a single bit, optional information elements can save on transmission bandwidth if the information is not present.

As can be seen in FIG. 7, a distinction is made in SIB 6 between the two UMTS modes FDD and TDD. The previously mentioned hierarchical structuring of the IEs using the symbol “>” can be recognized via this distinction. The symbol “>” contained in row 4 signifies that all succeeding IEs with the symbol “>>” are only applicable to the FDD mode, just as all IEs having the symbol “>>” after line 6 are only of significance for the TDD mode. Further hierarchical structuring using more than two symbols (>>> . . . ) is generally possible.

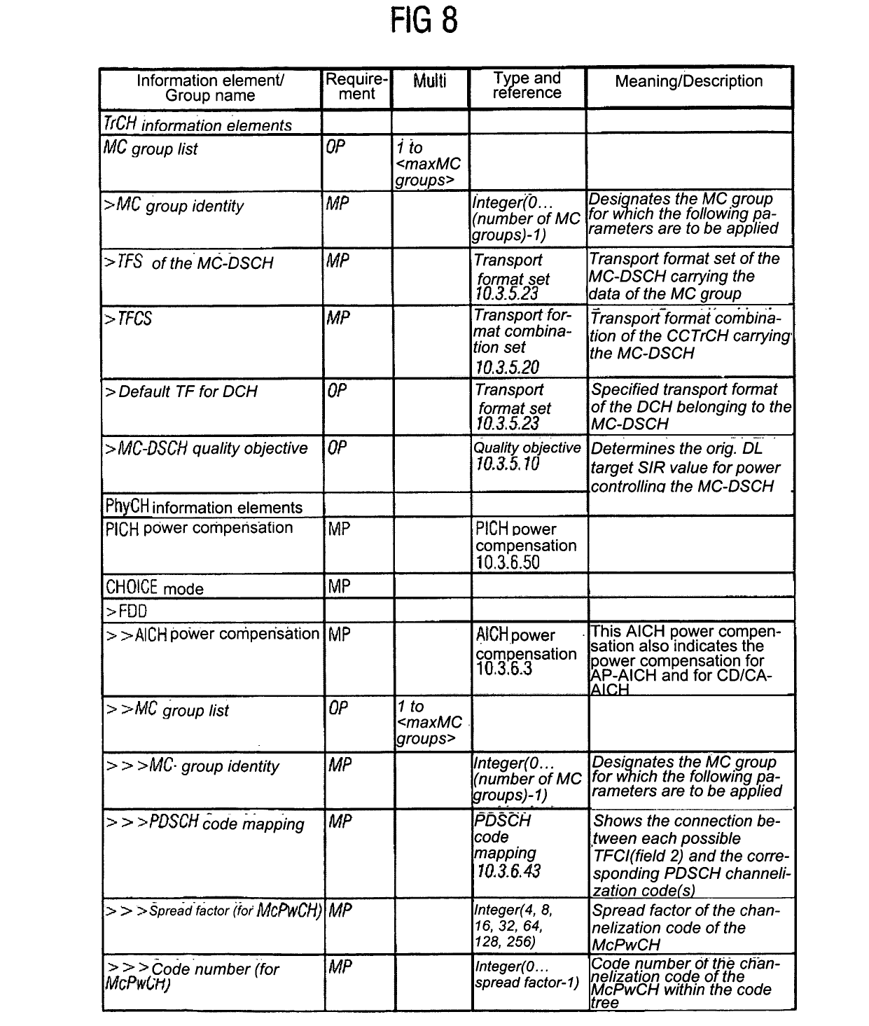

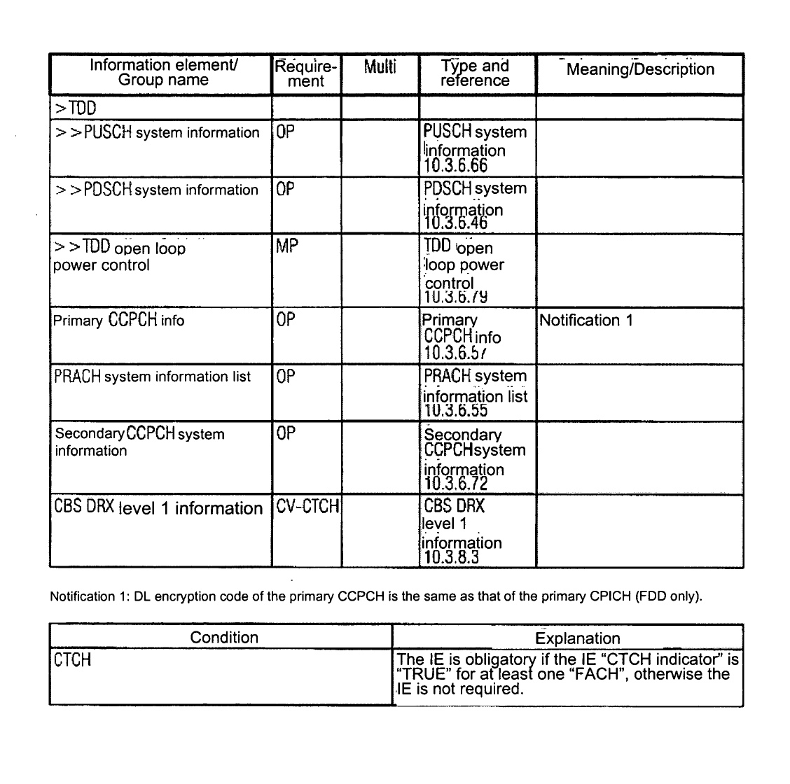

FIG. 8 (which extends across pages 8 and 9) shows the SIB 6 modified for the radio transmission of multicast information. Changes with respect to the prior art are indicated in italics. As the SIB 6 has to transmit information required, inter alia, for receiving an MC-DSCH, transport channel IEs initially have been added to the SIB 6 (rows 1 to 7). If it is a condition that a separate MCDSCH is configured for each MC group, row 2 in FIG. 8 indicates that all the following table elements indented with at least one “>” will be repeated as many times as indicated by this IE. A list of IEs sorted by MC groups is thus produced. This is to say that the IEs in rows 3 to 7 are repeated for each MC group. The IE in row 3 (MC group identity) identifies the MC group for which the following IEs are of significance. The transport format set of the MC-DSCH configured for the MC group is now generally made known via the IE “TFS of the MC-DSCH” (row 4) and the transport format combination set of the CCTrCH onto which the data of the MC-DSCH is mapped is made generally made known via the IE “TFCS.” A basic setting in terms of the transport format is transmitted for the DCH associated with the MC-DSCH with the fifth E in the list, although optimally this IE can be present. The last IE in the list indicates the reference value for power controlling the PDSCHs onto which the relevant MC-DSCH is mapped.

The generally applicable information for receiving the PDSCHs and for receiving the McPwCH is inserted in the SIB 6 below the IEs of the physical channels (rows 13 to 17). As this information is also specific to MC groups, there is also a list of IEs here which is sorted according to the MC groups. That is to say that, as previously in the case of the IEs for the transport channels, the IEs indented after row 13 with the symbol “>>>” are present once for each MC group. The MC group for which the following IEs (rows 15 to 17) are intended is, in turn, identified by the IE “MC group identity.” The IE “PDSCH code mapping” (row 15) has the same function as in the prior art. The assignment of TFCI(field 2) values to the spreading codes (channelization code) of the PDSCHs transporting the data of the MC-DSCH is transmitted via this IE. The IEs “spreading factor (for McPwCH)” and “code number (for McPwCH)” together describe the spreading code (channelization code) via which the McPwCH is spread before being sent over the air interface.

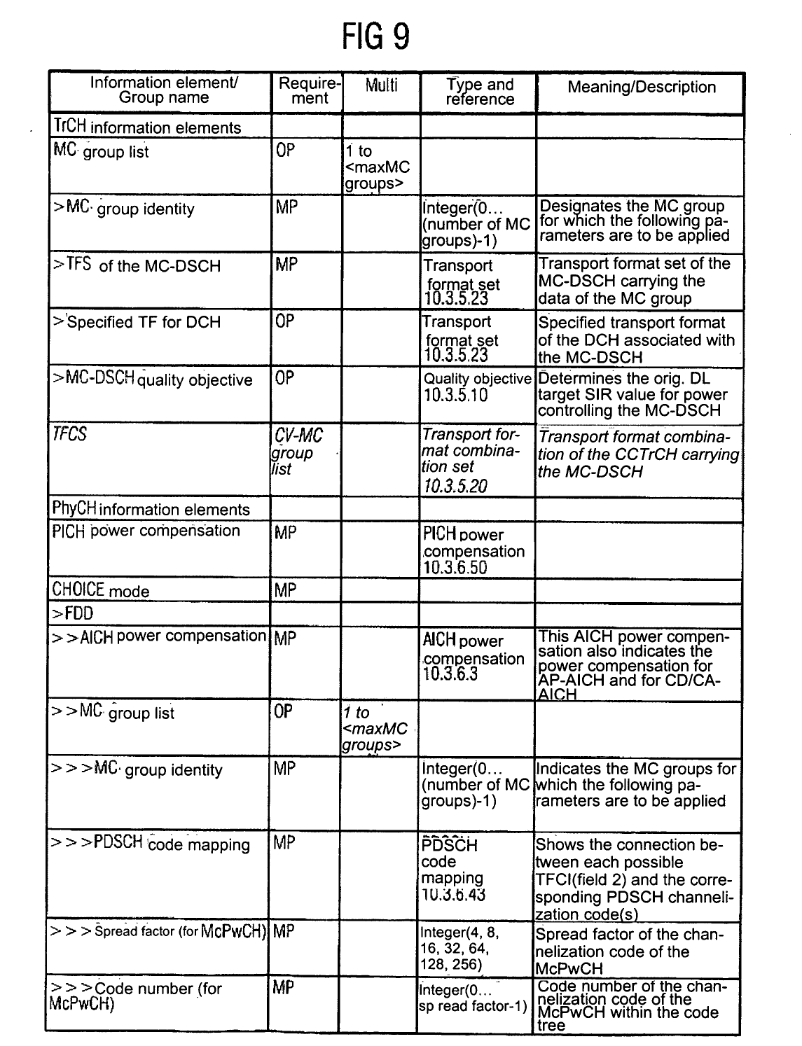

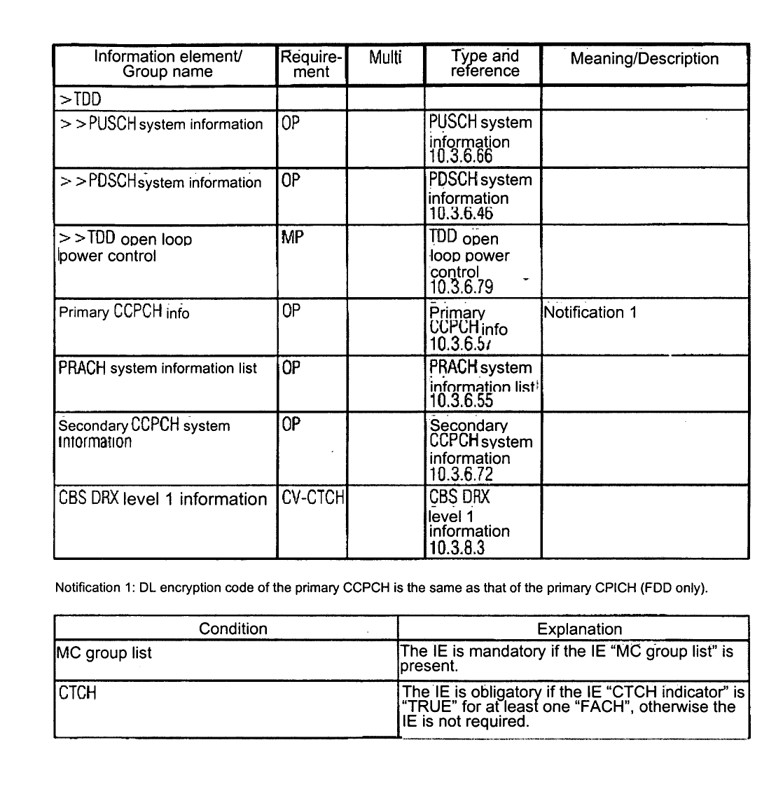

If one considers the case of several MCDSCHs' being sent in the transmitter (node B) time-multiplexed over a CCTrCH, then a user wishing to receive only one specific MC-DSCH and hence only information of one specific MC group, requires a TFCS taking into account the existence of all MC-DSCHs transmitted over the CCTrCH. A TFCS of this type therefore is no longer specific to one MC group but is equally applicable to several MC groups. The IE “TFCS” can, therefore, in a case such as this, be transmitted in the SIB 6 after the IEs specific to MC groups, as can be seen in FIG. 9 (which extends across pages 10 and 11). Changes with respect to FIG. 8 are indicated in italics.

Sending of the modified SIB 6 allows the information required for receiving a MC-DSCH and the associated PDSCH to be made generally known. As such, this information does not need to be transmitted individually over a dedicated connection for each UE if a mobile radio user wishes to use a multicast service. Fewer transmission capacities are consequently required for setting up a multicast service and the signaling effort can be effectively reduced. The parameters received by a UE via the SIB 6 furthermore can be stored, even if the UE does not wish to receive a multicast service at the present moment. As such the parameters required for setting up a multicast service are known in UE and can be established immediately if the UE wishes to participate in a multicast service at a later time. Consequently, a multicast connection generally will take less time to set up.

The parameters or, as the case may be, IEs proposed for radio transmission also can, however, be contained in a separate SIB to be introduced specially for multicast services.

Although the present invention has been described with reference to specific embodiments, those of skill in the art will recognize that changes may be made thereto without departing from the spirit and scope of the present invention as set forth in the hereafter appended claims.

1-16. (canceled)

17. A method for transmitting data in a UMTS mobile radio system, comprising:
transmitting parameters for receiving a multiply used channel from a base station to a mobile station;
evaluating the parameters in the mobile station, and
receiving, by the mobile station, of data which has been transmitted by the base station via the multiply used channel, reception being made possible by the parameters, wherein the parameters are known to all mobile stations supplied by the base station.

18. A method according to claim 17, wherein the parameters are transmitted into the service area of the mobile station by radio.

19. A method according to claim 17, wherein data peaks are transmitted over the multiply used channel.

20. A method according to claim 17, wherein the parameters are transmitted at a level of transmit power which will ensure that parameters may be received throughout a service area of the base station.

21. A method according to claim 17, wherein the parameters are evaluated by a plurality of mobile stations.

22. A method according to claim 17, wherein the data is received simultaneously by a plurality of mobile stations.

23. A method according to claim 17, wherein the data is data sent simultaneously to a group of mobile stations.

24. A system for transmitting data in a UMTS mobile radio system, comprising:
parts for sending parameters for reception of a multiply used channel from a base station to a mobile station;
parts for evaluating the parameters in the mobile station; and
parts for receiving data, sent from the base station, at the mobile station over the multiply used channel, with reception being made possible by the parameters, wherein the parameters are known to all the mobile stations supplied by the base station.

25. A system according to claim 24, wherein the parameters are transmitted into a service area of the mobile station by radio.

26. A system according to claim 24, wherein data peaks are transmitted over the multiply used channel.

27. A system according to claim 24, wherein the parameters are transmitted at a level of transmit power which will ensure that the parameters may be received throughout the service area of a base station.

28. A system according to claim 24, wherein the parameters are evaluated by a plurality of mobile stations.

29. A system according to claim 24, wherein the data is received simultaneously by a plurality of mobile stations.

30. A system according to claim 24, wherein the data is sent simultaneously to a group of mobile stations.
